(19) United States
(12) Patent Application Publication
(10) Pub. No.: US 2007/0049721 A1
(43) Pub. Date: Mar. 1, 2007

(54) Process for the preparation of polyesterpolyols and their use

(75) Inventors: Hartmut Nefzger, Pulheim (DE); Frithjof Hannig, Dusseldorf (DE); Peter Nordmann, Dormagen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/509,395

(22) Filed: Aug. 24, 2006

(30) Foreign Application Priority Data
Aug. 27, 2005 (DE) 102005040617.3

(51) Int. Cl. C08G 18/00

(52) U.S. Cl. 528/44; 521/172

(57) ABSTRACT

The present invention relates to a process for the accelerated preparation of polyesterpolyols in equilibrium by alcoholysis using microwave radiation, and to the production foamed and non-foamed polyurethane materials from these polyesterpolyols.

### CROSS-REFERENCE TO RELATED APPLICATION

The present patent application claims the right of priority under 35 U.S.C. §119 (a)-(d) of German Patent Application No. 10 2005 040 617.3, filed Aug. 27, 2005.

### BACKGROUND OF THE INVENTION

The present invention relates to a process for the preparation of polyesterpolyols by the alcoholysis of higher-molecular polyesterpolyols using microwave radiation.

Polyesterpolyols are valuable raw materials for polyurethane chemistry and are widely used industrially as flexible segment units in the production of foamed and non-foamed polyurethane (PUR) materials.

Their structural components of polyesterpolyols are usually aliphatic and/or aromatic polycarboxylic acids, optionally also in the form of their low-molecular esters with monofunctional alcohols and/or in the form of their anhydrides, including carbonic acid and its low-molecular derivatives, as well as polyols which have molecular weights of 62 to 1000, and preferably of 62 to 400 g/mol. These polyols can be used individually or in a mixture. In special cases, of course, it is also possible concomitantly to use a proportion of longer-chain polyether-polyols, such as those described e.g. in chapter 3.1.1. (page 58 et seq.) of the Plastics Handbook “Polyurethane”, 3rd edition, which have molecular weights of more than 1000 g/mol. The functionality of both the individual polycarboxylic acid components and the individual polyol components is usually 2 in this case. However, special properties can also be obtained by concomitantly using components having functionalities not equal to 2, i.e. components which have functionalities equal to, for example, 1, 3, 4, etc.

The resulting polyesterpolyols in turn have functionalities of 1.7 to 4.5, and preferably of 1.90 to 3.5. Their number-average molecular weight is 200 to 6000 g/mol, according to the application, and their consistency can range from amorphous through partially crystalline to more highly crystalline, according to the composition.

The technically most important method of preparing polyesterpolyols is the polycondensation of polycarboxylic acids with polyols with the elimination of water. This can be carried out, either with or without a catalyst, by reacting the components at an elevated temperature of 150 to 250° C. under normal pressure or, preferably, under a vacuum of 100 mbar to 0.1 mbar. Furthermore, such polycondensation reactions can also be carried out with the aid of an entraining agent such as, for example, toluene.

Polyesterpolyols derived from carbonic acid, on the other hand, are prepared by means of a polycondensation reaction of, for example, diphenyl carbonate, dimethyl carbonate or phosgene, with the elimination of phenol, methanol or hydrochloric acid. This polycondesation reaction may also be carried out with out without the use of a catalyst.

The stoichiometric ratio of carboxyl groups to hydroxyl groups, combined with the number-average functionality of these structural components, determines the molecular weight and the functionality of the resulting polyesterpolyol in a manner known to those skilled in the art. Polyesterpolyols which are used in the polyurethane sector generally have acid numbers of less than 3.5 mg KOH/g, and preferably of less than 3 mg KOH/g.

A problem which frequently arises in the technical field is that, when a polycondensation reaction is substantially complete, although the acid number is in the range as described above, the corresponding OH number is below the envisaged value. Such polyesterpolyols have values of almost 100% with respect to the carboxyl group conversion, so they have to be finished off with respect to the target OH number by adding more polyol. This finishing-off is effected such that the precalculated amount of polyol is metered in and is incorporated into the esterification, i.e. equilibrated, over a prolonged period of time such as, for example 4 to 10 hours, at elevated temperatures such as, for example 180 to 250° C. In chemical terms, this is a alcoholysis reaction. This alcoholysis reaction is needed not to bring the OH number to the target value, since the OH number is already reached by stirring the polyol with the polyesterpolyol to be finished off, but rather to bring the distribution of the individual oligomers of the polyesterpolyol into the polyester equilibrium in accordance with the Flory oligomer distribution function (see P. J. Flory, Principles of Polymer Chemistry, Cornell University Press, Ithaca 1953, p. 317 et seq.). Omission of the alcoholysis reaction means that a finished-off but not equilibrated polyesterpolyol contains an excessive and undesirable proportion of free, low-molecular, unesterified polyol. This in turn changes the material properties of the polyurethanes produced therefrom. For example, the glass transition temperature of the flexible segment domains is changed, and with it the hardness of the materials, as a consequence of a different proportion of hard segment domains. As the amount of polyol to be made up normally varies from batch to batch, the reproducibility of the material properties of the polyurethanes is not guaranteed. These are substantially the reasons why the additional equilibration step cannot be omitted, even though it is cost-intensive and time-consuming, and hence undesirable.

The causes of the need to make up with short-chain polyol can be an underdosing of polyol or overdosing of polycarboxylic acid This cause can be extensively eliminated by technical means. On the other hand, it is not possible reproducibly to predict the extent of secondary reactions leading to the formation of, for example, dioxane from diethylene glycol, tetrahydrofuran from 1,4-butanediol, or oxepan from 1,6-hexanediol. The extent of these cyclization reactions is critically dependent on the reaction conditions, i.e. in particular the reaction temperature, the type and amount of esterification catalysts used, and impurities introduced into the reaction, e.g. via the intermediate.

Such imponderables result in an unpredictable degree of ring ether formation which, as explained, has to be compensated by the making-up and equilibration of polyol, if possible up to the Flory oligomer equilibrium.

Polyesterpolyols of a given type that are in Flory equilibrium always have the same oligomer distribution, and thus, result in consistent material properties of the PUR materials produced therefrom.

Accordingly, the object of the present invention was to provide polyesterpolyol mixtures in Flory equilibrium and a simple time-saving process for their preparation, with the process temperature for obtaining a polyesterpolyol mixture in Flory equilibrium being as low as possible.

It has surprisingly been found that the above object could advantageously be achieved using microwave radiation.

### SUMMARY OF THE INVENTION

The invention relates to a process for the preparation of polyesterpolyols (A) by alcoholysis. This process comprises
a) mixing (B) one or more polyesterpolyols whose number-average molecular weight is greater than that of (A) the resultant polyesterpolyol, with (C) one or more polyols with a molecular weight of 62 to 1000, preferably of 62 to 400 g/mol,
   whereby (B) the polyesterpolyols are different from (C) the polyols, and
b) exposing this mixture to microwave radiation.

### DETAILED DESCRIPTION OF THE INVENTION

Suitable polyesterpolyols to be used as component (B) in the present invention typically have a number-average molecular weight of 200 to 6,000 g/mol, and functionalities of from 1.9 to 4.5, preferably from 1.95 to 3.5. These polyesterpolyols may be the reaction product of (1) one or more aliphatic and/or aromatic polycarboxylic acid units, with (2) one or more aliphatic, araliphatic and/or cycloaliphatic polyols. The polyester-polyols may contain carbonate groups. Mixtures of polyesterpolyols may be used as component (B) in accordance with the present invention.

The one or more polyols to be used as component (C) in accordance with the present invention are typically free of ester groups. Suitable compounds to be used as polyols (C) have a molecular weight of from about 62 to about 1000 g/mol, and preferably from about 62 to about 400 g/mol. The functionality of these polyols varies and may range from about 1 to about 4 or more, but a functionality of about 2 is preferred. Mixtures of such polyols can also be used as desired. The molecular weight of the polyols (C) is lower than the molecular weight of the polyesterpolyols (B).

As used herein, microwave radiation is understood as meaning the frequency range from 300 MHz to 300 GHz, or the wavelength range from 1 m to 1 mm (see Römpp, Chemie Lexikon, Thieme Verlag, 9th enlarged and revised edition 1995, p. 2785).

Although numerous syntheses for the preparation of low-molecular weight compounds by means of microwave radiation in solvents are described in the literature, there are no references to the preparation of polyesterpolyols by this method or, in particular, to a preparation in solvents (see B. L. Hayes, Microwave Synthesis, Chemistry at the Speed of Light, CEM Publishing, Matthews, NC 28105, pp 77-156).

Surprisingly, it has been found that microwaves markedly accelerate the alcoholysis of polyesterpolyols, even at very low temperatures.

Commercially available microwave apparatuses which are suitable for the process herein include both monomodal and multimodal apparatuses. Energy inputs of between 10 W and several hundred W can be produced, depending on the particular model. Of course, the operation can also be carried out with a greater or lesser energy input if required.

The commercially available monomodal microwave apparatus “Discover” from CEM (frequency 2.45 GHz), for example, can be used in a typical experimental set-up. A 100 ml reaction vessel was used in the experiments described in greater detail below. One of the distinguishing features of the CEM apparatus is that it can generate an energy density which is relatively high for microwave apparatuses and which can also be maintained for prolonged periods by means of the simultaneous cooling facility. The temperature stress on the reaction mixture can also be kept very low.

Preferred energy densities are above 200 watt/liter. A further preference is to radiate the microwave energy with simultaneous cooling of the reaction mixture such that only a relatively low reaction temperature is reached despite a high energy input. The cooling is preferably effected with compressed air, but it is also possible to use other cooling systems, partocularly those with a liquid cooling medium.

Of course, the use of microwave apparatuses is not restricted to monomodal apparatuses, it is also possible to use the multimodal apparatuses already described above. Multimodal apparatuses are comparable to the generally familiar household appliances and have inhomogeneous microwave fields, i.e. so-called hot and cold spots which occur inside the microwave chamber because of the non-uniform microwave distribution and are extensively compensated for by the rotation of the microwave plate.

Monomodal apparatuses, on the other hand, have a homogeneous microwave field and their special chamber design eliminates such hot and cold spots.

The process according to the invention can be carried out not only batchwise but also continuously, through the use of a pump and appropriate tube reactors. It is also possible to connect several microwave apparatuses in series or parallel.

The alcoholysis reaction of the polyesterpolyols using microwave radiation can also be accelerated by adding catalysts, although the reaction is preferably carried out without a catalyst.

The process can also be carried out under elevated or reduced pressure. It is particularly advantageous to use reduced pressure if, in addition to alcoholysis, it is also intended, for example, to lower the acid number, i.e. small amounts of water, for example, have to be removed from the reaction mixture.

Carrying out the process under elevated pressure is considered in cases where the boiling point of one of the reaction components is below the reaction temperature of the process (predetermined e.g. by other boundary conditions).

The process is preferably carried out without using a solvent. It is optionally possible concomitantly to use a solvent in special cases such as, for example, for polyesterpolyols with a very high molecular weight and/or a correspondingly high viscosity.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

### Comparative Example

In a 41 four-necked flask fitted with a stirrer, a thermometer and a reflux condenser, 1500 g of a polybutylene adipate having a hydroxyl number of 50 mg KOH/g and an acid number of 0.4 mg KOH/g were stirred rapidly with 30 g of 1,4-butanediol at 70° C. A sample was taken (“zero-value sample”) and the reaction temperature was then raised to 200° C. At this temperature further samples were taken after 1, 2, 4 and 8 hours for gas chromatographic analysis.

| Reaction time | Free butanediol |
|---|---|
| [h] | [wt. %] |
| 0 | 2.6 |
| 1 | 2.3 |
| 2 | 1.9 |
| 4 | 1.6 |
| 8 | 1.5 |

Theoretical value of free butanediol for complete incorporation into the ester: 0.8 wt. %.

The Comparative Example shows that even 8 hours at 200° C. are not sufficient to reach Flory equilibrium in a conventional transesterification reaction.

### Example 1

### According to the Invention

In a 100 ml one-necked glass flask, 100 g of a polybutylene adipate with a hydroxyl number of 50 mg KOH/g and an acid number of 0.4 mg KOH/g were stirred rapidly with 2 g of 1,4-butanediol at 70° C. This mixture was then exposed to microwave radiation in a monomodal microwave apparatus from CEM (Discover) under the following reaction conditions: reaction time: 2 h, constant microwave energy input of 300 W under continuous cooling with compressed air. The maximum reaction temperature measured by an infrared sensor was 89° C.

The reaction mixture was then analysed by gas chromatography for the proportion of free butanediol. 1.0 wt. % of free butanediol was found; theory: approx. 0.8%.

The value of the zero-value sample was 2.6 wt. % of free butanediol (theory: 2.4%).

A comparison of the experiments shows that, in the process according to the invention, Flory equilibrium is reached in practice after only 2 h at low temperature (approx. 90° C. instead of 200° C. in the comparative test).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the preparation of polyesterpolyols (A), comprising
a) mixing (B) one or more polyesterpolyols having a number-average molecular weight that is greater than the number-average molecular weight of (A) the polyesterpolyols to be prepared, with (C) one or more polyols having a molecular weight of 62 to 1000 g/mol,
whereby (B) the polyesterpolyols are different from (C) the polyols, and
b) exposing the mixture from a) to microwave radiation.

2. The process of claim 1, wherein (C) said one or more polyols has a molecular weight of 62 to 400 g/mol,

3. The process of claim 1, wherein the microwave radiation is monomodal microwave radiation with homogeneous microwave radiation fields.

4. The process of claim 1, wherein the microwave radiation is multimodal microwave radiation with heterogeneous microwave radiation fields.

5. The process of claim 1, wherein the energy input of the microwave radiation is at least 10 W/l.

6. The process of claim 1, wherein the energy input of the microwave radiation is at least 50 W/l.

7. The process of claim 1, wherein the energy input of the microwave radiation is preferably more than 200 W/l.

8. The process of claim 1, wherein (B) said polyesterpolyols are synthesized from (1) one or more aliphatic and/or aromatic polycarboxylic acid units, and (2) one or more aliphatic, araliphatic and/or cycloaliphatic polyols, which have a molecular weight of 62 to 1000 g/mol.

9. The process of claim 8, in which (B)(2) said one or more aliphatic, araliphatic and/or cycloaliphatic polyols have a molecular weight of 62 to 400 g/mol.

10. The process of claim 1, wherein (B) said one or more polyesterpolyols have number-average molecular weights of 200 to 6000 g/mol and functionalities of 1.9 to 4.5.

11. The process of claim 10, in which (B) said one or more polyester polyols have a functionality of 1.95 to 3.5.

12. The process of claim 1, wherein (B) said one or more polyesterpolyols contain carbonate groups.

13. A process for the production of foamed and non-foamed polyurethane materials comprising reacting a polyisocyanate component with (A) a polyesterpolyol which is prepared by the process of claim 1.
